(19) United States
(12) Patent Application Publication
(10) Pub. No.: US 2006/0047951 A1
(43) Pub. Date: Mar. 2, 2006

(54) Continuing public key infrastructure operation while regenerating a new certification authority keypair and certificate

(76) Inventors: Michael Reilly, San Jose, CA (US); Andrew Nourse, Woodside, CA (US); Max Pritikin, Santa Cruz, CA (US); Adina Simu, San Jose, CA (US); Wei-Chun Chao, Santa Cruz, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 10/929,079

(22) Filed: Aug. 27, 2004

(51) Int. Cl. H04L 9/00

(52) U.S. Cl. 713/158

(57) ABSTRACT

In accordance with one embodiment, continued PKI operation during regenerating a new Certification Authority (CA) keypair and certificate or the like is provided by a root Certification Authority preparing a second CA certificate responsive to a request from a subordinate certification authority. The root Certification Authority and the subordinate certification authority store copies of the second CA certificate for use when the current CA certificate expires. Accordingly, existing trust relationships among a plurality of certificate authorities may be maintained during regeneration, node addition or the like.

### FIELD OF THE INVENTION

The present invention generally relates to cryptographic public key infrastructure (PKI) in computer networks. The invention relates more specifically to techniques for continuing PKI operation while regenerating a new Certification Authority (CA) keypair and certificate.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Typically, a public key infrastructure (PKI) is comprised of one or multiple (hierarchical) certification authorities (CA) and a number of clients connected through trust relationships based on digital signatures. The root of all this trust lies with the top of the hierarchy, namely with the keypair associated with the top or root-level CA certificate. The certificate may conform to ITU Recommendation x.509. The clients may be processes running on routers or switches in the network.

Keypairs and certificates have finite lifetimes, which should be chosen based on factors like key length, cryptographic algorithms to be used, estimations about how the processing power available to an attacker would change in the future, etc. It is generally accepted that keypairs and certificates should be changed or regenerated periodically, for example, when new clients enter the network.

The initial deployment of a PKI in a complex network of many routers and switches is a highly cumbersome operation. Conventionally, the trust relationships are spread in the network slowly through manual operations. Once the PKI is deployed, it is highly desirable to have ways to use existing trust relationships, and existing keys, to distribute the new keys or certificates, thus allowing for a smooth switchover to the new credentials once the old ones expire.

One possible approach to address this problem is to have the CA generate one new self-signed CA certificate, and two cross-signed certificates. However, this approach has numerous disadvantages. Such approaches require a repository where these CA certificates will be kept, which is accessible at all times by the clients. The publishing of certificates in the repository has to be done manually by an operator. Delays in publishing, or impossibility of accessing the repository due to network downtime, will result in malfunctions in the PKI network elements in which valid certificates or certificate revocation lists (CRLs) cannot be verified by certain peers.

Based on the foregoing, there is a clear need for techniques for continuing PKI operation while regenerating a new Certification Authority (CA) keypair and certificate.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting an example network in which continuing PKI operation while regenerating a new Certification Authority (CA) keypair and certificate may be implemented in one embodiment;

FIG. 2A is a flow diagram that illustrates a high level overview of one embodiment of a process for generating a rollover certificate in a packet network in one embodiment;

FIG. 2B is a flow diagram that illustrates a high level overview of a process for servicing a request for a CA certificate operable with the processing depicted by FIG. 2A in one embodiment;

FIG. 2C is a flow diagram that illustrates a high level overview of a process for servicing a request for a local certificate operable with the processing depicted by FIG. 2A in one embodiment;

FIG. 2D is a flow diagram that illustrates a high level overview of a process for detecting and exchanging CA certificates operable with the processing depicted by FIG. 2A in one embodiment;

FIG. 2E is a flow diagram that illustrates a high level overview of a process for updating a CA certificate operable with the processing depicted by FIG. 2A in one embodiment;

FIG. 2F is a flow diagram that illustrates a high level overview of a process for updating a local certificate operable with the processing depicted by FIG. 2A in one embodiment;

FIG. 3 is a functional diagram that illustrates a hierarchical relationship among nodes using the process of FIGS. 2A-2F in one embodiment; and

FIG. 4 is a block diagram that illustrates a computer system upon which an embodiment may be implemented.

### DETAILED DESCRIPTION OF THE PREFERRED EMBODIMENT

A method and apparatus for continuing public key infrastructure (PKI) operation while regenerating a new Certification Authority (CA) keypair and certificate is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Method of Rolling Over a Certificate from a Certification Authority for a Network
3.1 Process of Generating a Roll Over Certificate
3.2 Process of Distributing Roll Over Certificates
3.3 Process of Updating Certificate(s) at the Client
4.0 Implementation Mechanisms-Hardware Overview
5.0 Extensions and Alternatives
   1.0 General Overview

The needs identified in the foregoing Background, and other needs and objects that will become apparent for the following description, are achieved in the present invention, which comprises, in one aspect, a method for continuing operation of a public key infrastructure (PKI) that includes a certification authority (CA) and a requester. In one example embodiment described here, there are four (4) keypairs in use, two (2) on the CA side, K1 and K2, respectively, and two (2) on the router/client/requestor side, rK1 and rK2, respectively. The requestor and the certification authority have a trust relationship based upon a first CA certificate produced by the CA and signed using a first private key K1-private of a first keypair K1. The first CA certificate has a first validity period L1 that establishes a lifetime for the validity of the CA certificate. In accordance with one embodiment, the method includes the Certification Authority generating a second keypair K2, having a second public key K2-public and a second private key, K2-private. The second keypair K2 can be cryptographically unrelated to the first keypair K1. A future valid second CA certificate is generated. The future valid second CA certificate is signed with the second private key K2-private of the second keypair K2 and has a second validity period L2 beginning sometime in the future. The issuer name and subject name of the second CA certificate are substantially identical to the issuer name and subject name of the first CA certificate. The second validity period L2 begins substantially concurrently with expiration of the first validity period of the first CA certificate.

In one embodiment, the method includes the certification authority receiving a request for a new CA certificate from the requester. The certification authority prepares a message to the requester, wherein the message includes the second CA certificate. The certification authority signs the message using the first private key K1-private and sends the message to the requestor for storing the second certificate for use when the first certificate expires. In one embodiment, preparing a message to the requestor comprises preparing a PKCS#7 message containing the second CA certificate and signed with the first private key K1-private. A PKCS#7 message is an RSA standard message for certification packaging using encrypted messages.

In one embodiment, the method includes receiving from a requestor a request for a new local (i.e., client) certificate. The requestor signed the request with the requestor's first private key rK1-private. The request includes the first certificate signed with the Certification Authority's first private key K1-private and the request is enveloped using the CA's second public key K2-public. A new local certificate having a validity period L3 that begins at the start of the second validity period L2 of the second CA certificate is automatically generated. The local certificate is signed using the second private key K2-private and sent to the requestor for storing the local certificate for use when the requestor's current local certificate expires. In one embodiment, the request comprises a first data layer in PKCS#10 format that is signed with the requestor's second private key rK2-private key and a second data layer in PKCS#7 format that is signed with the requestor's first private key rK1-private, and enveloped with the Certificate Authority's second public key K2-public. The second layer also contains the local certificate signed by the CA with the Certificate Authority's first private key K1-private (which certificate contains to the requestor's first public key rK1-public).

In one embodiment, the requestor determines that the first CA certificate is expired and exchanges the second CA certificate for the first CA certificate at expiration of the first CA certificate.

In another aspect, a method for continuing operation of a public key infrastructure (PKI) that includes a certification authority (CA) and a requestor is provided. The requestor and the certification authority have a trust relationship based upon a first CA certificate produced by the CA and signed using a first private key K1-private of a first keypair K1. The first CA certificate has a first validity period L1 that establishes a lifetime for the validity of the CA certificate. In accordance with one embodiment, the method includes the requestor determining that the first CA certificate is about to expire. The requestor sends a request to the Certification Authority for a new CA certificate. The requestor stores the new CA certificate for use when the first certificate expires, if the new CA certificate is received.

In one embodiment, the method also includes determining that a current local certificate is about to expire. A request is sent to the Certification Authority for a new local certificate. The requestor signs the request with the first private key rK1-private. The request includes the first certificate signed with the first private key K1-private and is enveloped using the second public key K2-public. The new local certificate is stored for use when the current local certificate expires, if the new local certificate is received.

In other aspects, the invention encompasses a computer apparatus and a computer-readable medium configured to carry out the foregoing steps.

2.0 Structural and Functional Overview

Embodiments of the present invention enable a certification authority (CA), whether a root authority or a subordinate authority, to change its key and CA certificate, then propagate these changes in the PKI network, including subordinate CAs and existing end clients, in a seamless and secure fashion without manual intervention of an administrator. As used herein, the term public key infrastructure (PKI) is defined to mean components used to securely distribute public keys.

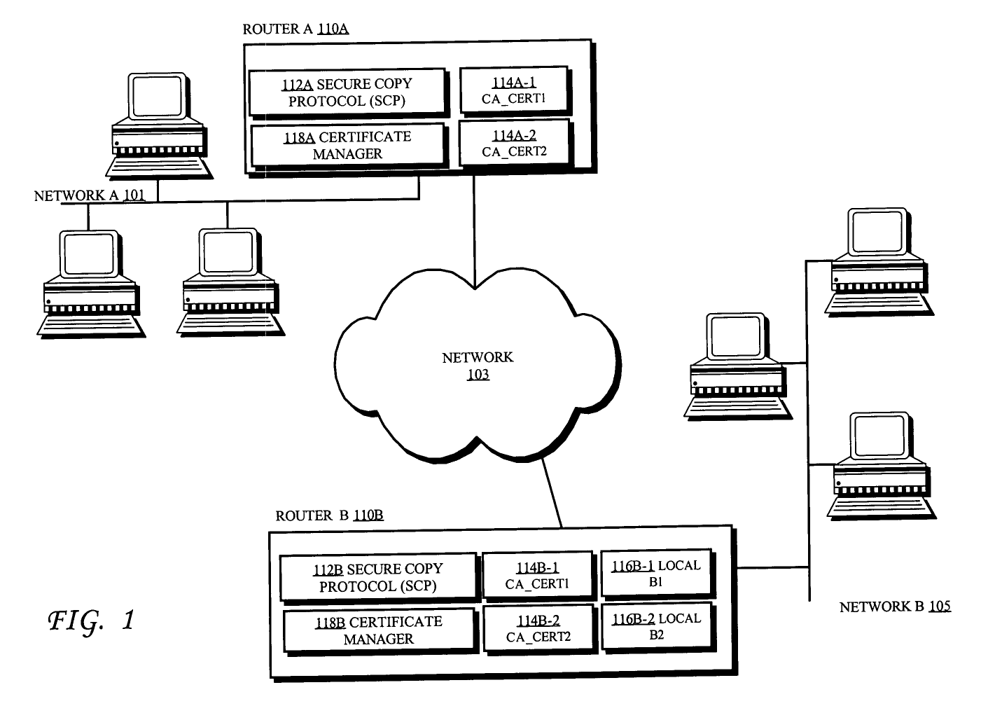

FIG. 1 is a block diagram depicting an example network in which continuing PKI operation while regenerating a new Certification Authority (CA) keypair and certificate may be implemented in one embodiment of the invention. While the invention is illustrated generally with reference to an example embodiment of peered router devices supporting Secure Copy Protocol (SCP) sessions in an IP network environment, the present invention does not require such implementation, and in some embodiments, techniques according to the invention may be implemented using other transport mechanisms and for other protocols and/or in other types of peered devices, such as routers, gateways, wireless access points or various combinations thereof.

In the example configuration depicted by FIG. 1, router 110A acts as a certification authority. While the invention is illustrated with reference to an example embodiment in which routers act as certification authorities, the invention is not so limited, and in alternative embodiments, other nodes on network A 101 and network B 105 could be the certification authorities. Router 110A may be a root certification authority or a subordinate certification authority. In addition, router 110A connects Network A 101 to other networks, such as network 103. Router 110A is communicatively coupled to a second router 110B through the network 103. Router 110B also serves as a certification authority. In the example illustrated by FIG. 1, router 110B is also a subordinate certification authority. Additionally, router 110B connects network B 105 to network 103. In the embodiment illustrated by FIG. 1, peered routers 110A and 110B enable devices on network A 101 and on network B 105 to securely communicate with one another and to other devices not shown in FIG. 1 by establishing a trust relationship between Routers 110A and 110B. This trust relationship is based upon an exchange of CA certificates signed using a key pair between Routers 110A and 110B. In one embodiment, digital signatures and PKCS#7 are used to transition the trust from router 110A to router 110B. Further, trust may be propagated from either or both of router 110A or router 110B to other nodes in networks 101, 103 and 105.

Networks 101 and 105 may be any type of network and may be different from one another. For example, networks 101, 103 and 105 may be one or more other public networks or one or more private networks in various embodiments. Routers 110A and 110B comprise secure copy protocol (SCP) 112A, 112B, which enables secure communications for exchanging certificates with one another and with other peers. While the present invention is being illustrated using the example of SCP 112A, 112B sessions between routers 110A and 110B connected back to back over a network link (i.e., network 103), the present invention is not limited to this embodiment.

In one embodiment, routers 110A and 110B include a certification authority manager 118A, 118B for managing the assignment and exchanging of CA certificates of authority between routers 110A and 110B by processes using secure copy protocol 112A, 112B. The certification authority manager 118A may be part of an operating system of a router, a process remotely located on a separate platform from router 110A or integrated or partially integrated with another process (not shown).

As can be seen from FIG. 1, routers 110A and 110B possess a first CA certificate 114A-1 and 114B-1 (CA-cert-1). The routers 110A and 110B exchange self-signed CA Certificates 114A-1 and 114B-1 (CA-cert-1) in order to establish a trust relationship between these routers 110A and 110B. In accordance with one embodiment, a second CA certificate 114A-2 and 114B-2 (CA-cert-2) is prepared by a root Certification Authority, i.e., router 110A in the example of FIG. 1, responsive to a request from a subordinate certification authority, i.e., router 110B in FIG. 1. The second CA certificate 114A-2 and 114B-2 (CA-cert-2) is valid at a future time, which may begin at the expiration of Certificates 114A-1 and 114B-1 (CA-cert-1).

As can be seen from FIG. 1, a subordinate certification authority, i.e., router 110B may include a local certificate 116B-1. The router 110B will use the local certificate 116B-1 for normal peer communications. This enables router 10B to avoid needlessly exposing the Certification Authority keys to possible compromises during routine communications tasks. In one embodiment, responsive to a request from a subordinate certification authority, i.e., router 110B in FIG. 1, a root Certification Authority, i.e., router 110A in the example of FIG. 1 will prepare a second local certificate 116B-1 and send the second local certificate 1161B-2 to the requesting subordinate certification authority for storing for use when the current local certificate 116B-1.

3.0 Method of Rolling Over a Certificate from a Certification Authority for a Network

In accordance with one embodiment, continued PKI operation during regenerating a new certification authority keypair and certificate is provided by a root Certification Authority preparing a second CA certificate (CA-cert-2) responsive to a request from a subordinate certification authority. The root Certification Authority and the subordinate certification authority store copies of the second CA certificate (CA-cert-2) for use when the current CA certificate (CA-cert-1) expires. Accordingly, existing trust relationships among a plurality of certificate authorities may be maintained during regenerating a new certification authority keypair and certificate. In one embodiment, in the case where a CA key compromise occurs, existing trust relationships are lost, and steps of re-establishing trust relationships, similar with the first-time PKI deployment will be performed.

3.1 Process of Generating a Roll Over Certificate

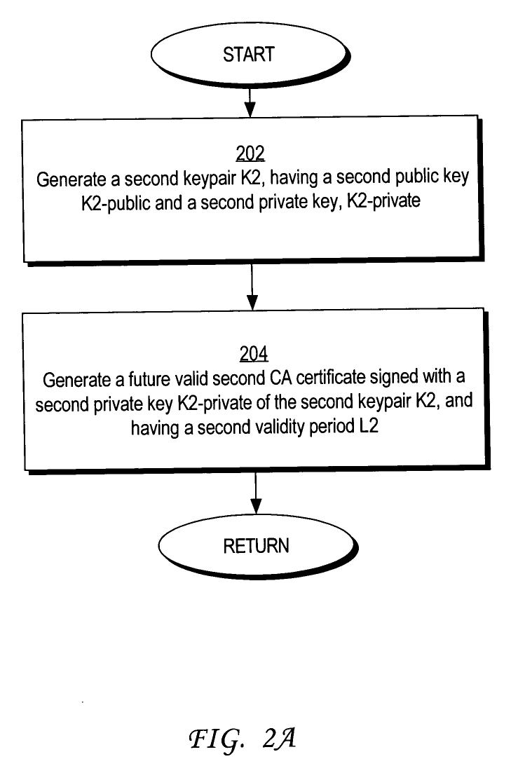

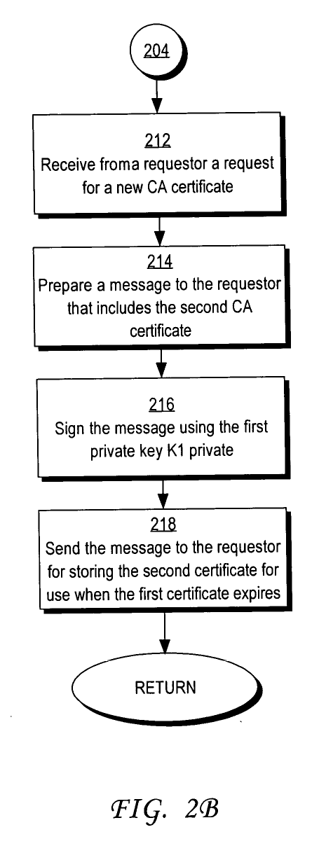

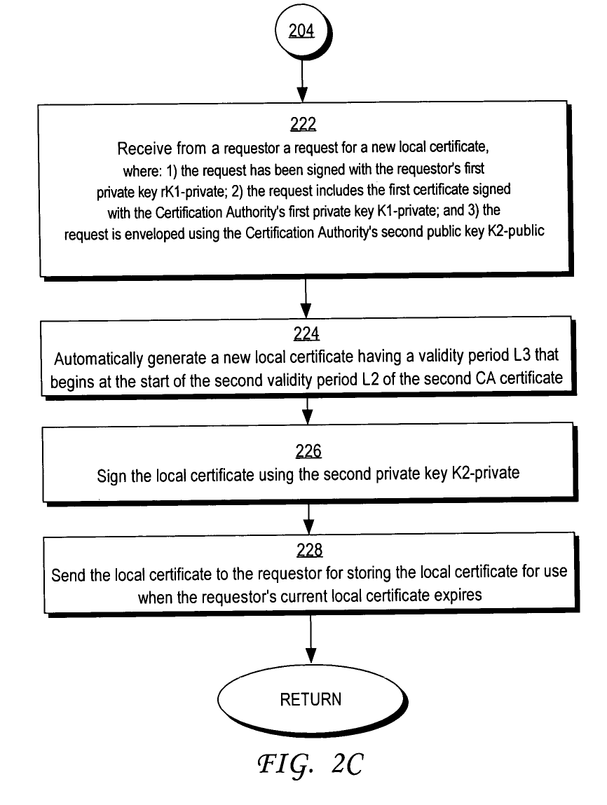

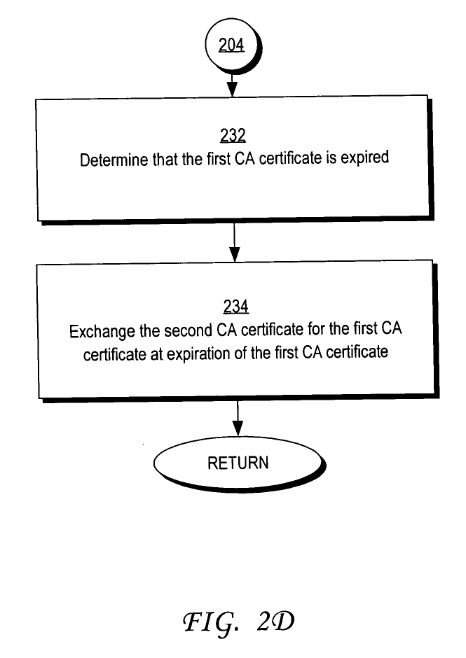

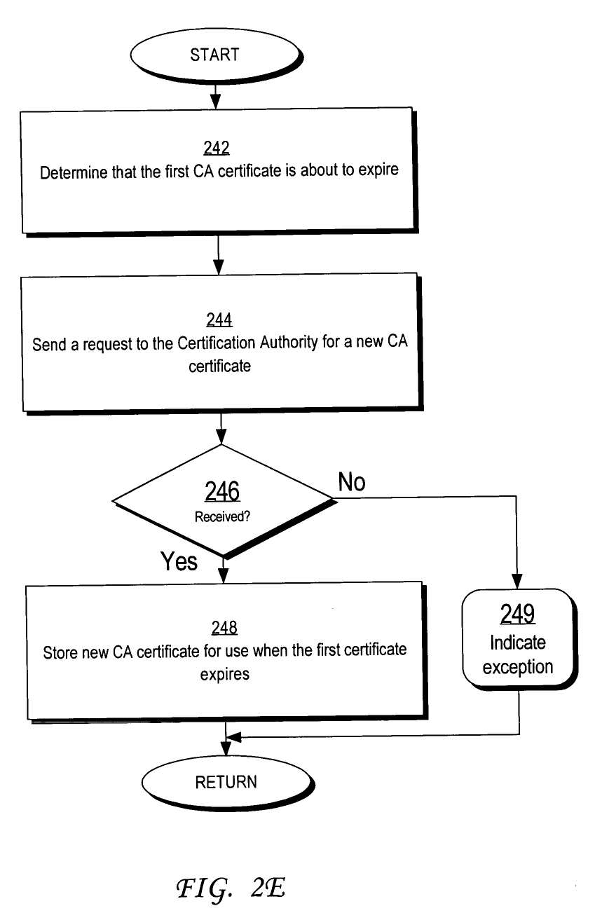

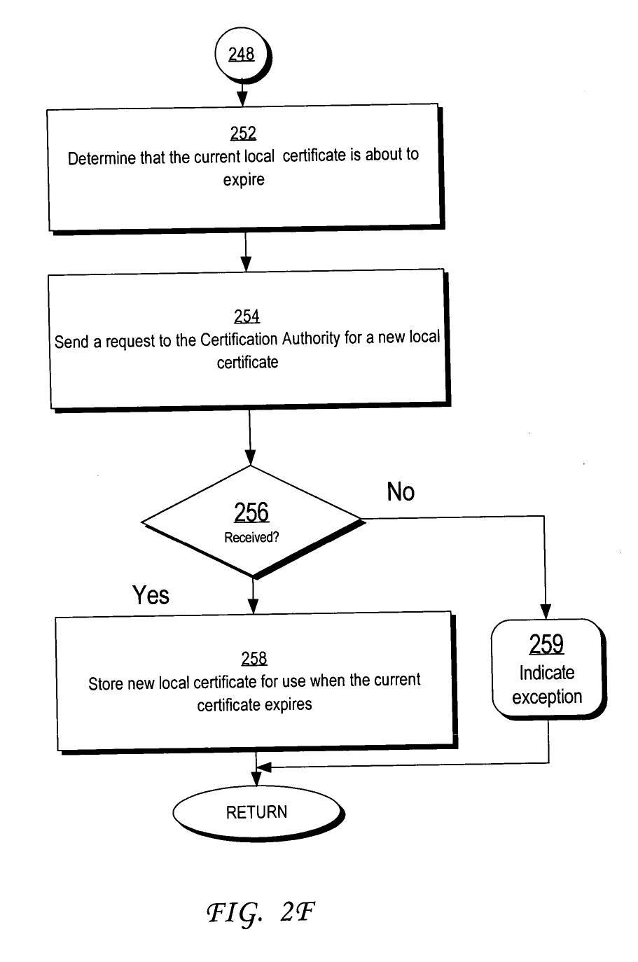

FIG. 2A is a flow diagram that illustrates a high level overview of one embodiment of a process for generating a rollover certificate in a packet network. As shown in FIG. 2A, a certification authority generates a second keypair K2, having a second public key K2-public and a second private key, K2-private (block 202). The certification authority generates a future valid second CA certificate signed with a second private key K2-private of the second keypair K2, and having a second validity period L2 (block 204).

For example, a root Certification Authority, such as router 110A, may have a self-signed CA certificate (CA-cert-1) with the attributes shown in table 1:

TABLE 1
Sample root CA with a self signed certificate (CA-cert-1)

| Line | |
|---|---|
| No. | CA-cert-1: |
| 1 | SubjectName: MyCA |
| 2 | IssuerName: MyCA |
| 3 | PublicKey: K1-public |
| 4 | ValidFrom: Jan. 1, 2004 |
| 5 | ValidUntil: Dec, 31, 2006 |
| 6 | Signed using: K1-private |

While CA-cert-1 is still valid (before Dec. 31, 2006), the certification authority, i.e., router 110A, generates a new keypair (K2) and a new CA certificate (CA-cert-2) with the attributes shown in table 2:

TABLE 2
L
Sample root CA with a self signed certificate (CA-cert-2)

| Line | |
|---|---|
| No. | CA-cert-2: |
| 1 | SubjectName: MyCA |
| 2 | IssuerName: MyCA |
| 3 | ublicKey: K2-public |
| 4 | ValidFrom: Jan. 1, 2007 |
| 5 | ValidUntil: Dec. 31, 2009 |
| 6 | Signed using: K2-private |

The CA certificates, CA-cert-1 and CA-cert-2, need not be cryptographically related to one another. The CA certificates CA-cert-1 and CA-cert-2 are both self-signed certificates. In one embodiment, the CA certificates, CA-cert-1 and CA-cert-2 have the same IssuerName and SubjectName as indicated by lines 1, 2 of Table 1 and lines 1, 2 of Table 2. The IssuerName is used during peer authentication, before the certificate exchange happens, to specify which CAs the router trusts. In order to insure communication between peers enrolled with the old and the new CA instances, the IssuerName and SubjectName are preserved. Additionally, the period of validity for CA-cert-2 starts at the time CA-cert-1 expires as indicated by line 5 of Table 1 and line 4 of Table 2. In other words, CA-cert-2 validity starts sometime in the future, i.e., CA-cert-2 is a future valid CA certificate. Regular authentication/enrollment requests may be served using the current CA-cert-1. Certificate Revocation Lists (CRL) may be signed using K1.

3.2 Process of Distributing Roll Over Certificates

When a superior CA in the hierarchy receives a request for a new CA certificate from a subordinate CA, the superior CA sends the second CA certificate to the requestor in a re-authentication server process. As illustrated by FIG. 2B, which is a flow diagram that illustrates a high level overview of a process for servicing a request for a CA certificate operable with the processing depicted by FIG. 2A in one embodiment. The Certification Authority receives a request for a new CA certificate from a requestor (block 212). The Certification Authority prepares a message to the requestor that includes the second CA certificate prepared in block 204 of FIG. 1 (block 214). The Certification Authority signs the message using the first private key K1-private (block 216). The Certification Authority sends the message to the requester, which stores the second certificate for use when the first certificate expires (block 218).

When a superior CA in the hierarchy receives a request for a new local certificate from a subordinate CA, the superior CA generates a new local certificate based upon credentials provided by the requester and sends the second local certificate to the requester in a re-enrollment server process. As illustrated by FIG. 2C, which is a flow diagram that illustrates a high level overview of a process for servicing a request for a local (client) certificate operable with the processing depicted by FIG. 2A in one embodiment. The Certification Authority receives a request for a new local certificate from a requestor. The requester signs the requestor's first private key rK1-private (block 222). The request includes the first certificate signed with the Certification Authority's first private key K1-private and the request is enveloped using the Certification Authority's second public key K2-public. The Certification Authority automatically generates a new local certificate having a validity period L3 that begins at the start of the second validity period L2 of the second CA certificate (block 224). The Certification Authority signs the local certificate using the second private key K2-private (block 226). The Certification Authority sends the local certificate to the requestor, which stores the local certificate for use when the requestor's current local certificate expires (block 228).

In one embodiment, the CA is responsible for watching the expiration of its CA-cert-1, swapping it at the right moment with CA-cert-2 and issuing a new CRL signed using K2. For example, FIG. 2D is a flow diagram that illustrates a high level overview of a process for detecting and exchanging CA certificates operable with the processing depicted by FIG. 2A in one embodiment. As illustrated by FIG. 2D, the Certification Authority determines that the first CA certificate is expired (block 232). The Certification Authority exchanges the second CA certificate for the first CA certificate at expiration of the first CA certificate (block 234).

3.3 A Process of Updating the Certificate(s) at the Client

When a client notices that its own local certificate or the current CA certificate (CA-cert-1) is about to expire, the client sends a request to the CA, asking for the new CA certificate (CA-cert-2) in a re-authentication client process. As illustrated by block 224 of FIG. 2C, the CA replies with a PKCS#7 message containing the new CA-cert-2. The message is signed using K1-private (corresponding to CA-cert-1, that the client already trusts) so that the client can verify the authenticity of the message. If the signature check passes, the client stores the CA-cert-2 so that the client can transition to the CA-cert-2 certificate once the current CA-cert-1 expires.

For example, FIG. 2E is a flow diagram that illustrates a high level overview of a process for updating a CA certificate operable with the processing depicted by FIG. 2A in one embodiment. The client determines that the first CA certificate is about to expire (block 242). The client sends a request to the Certification Authority for a new CA certificate (block 244). A determination is made whether a new CA certificate is received (block 246). If the new CA certificate is received, the client stores the new CA certificate for use when the first certificate expires (block 248). Otherwise, an exception is indicated (block 249).

Once CA-cert-2 has been obtained, the client can request a new local certificate for itself signed with the new K2 server key in a re-enrollment client process. In one embodiment, the request is encapsulated in the form of a PKCS#7 message that includes the existing router certificate (signed by K1) and signed by the corresponding private key of the client to enable automatic grant of the request by the Certification Authority (based on the CA policy). The PKCS#7 enveloping is performed using K2-public. In one embodiment, the request comprises a first data layer in PKCS#10 format that is signed with the requestor's second private key rK2-private key and a second data layer in PKCS#7 format that is signed with the requestor's first private key rK1-private, and enveloped with the Certificate Authority's second public key K2-public. The second layer also contains the local certificate signed by the CA with the Certificate Authority's first private key K1-private (which certificate contains to the requestor's first public key rK1-public).

When receiving this request, the server can verify that the request comes from a client that holds a valid certificate. The server could automatically generate a new certificate, with a validity period starting when CA-cert-2 becomes valid, sign it using K2, and send this certificate back to the requester. The client stores the new, not-yet-valid certificate so it can transition to it when the old certificate expires.

FIG. 2F is a flow diagram that illustrates a high level overview of a process for updating a local certificate operable with the processing depicted by FIG. 2A in one embodiment. The client determines that the current local certificate is about to expire (block 252). The client sends a request to the Certification Authority for a new local certificate (block 254). A determination is made whether a new local certificate is received (block 256). If the new CA certificate is received, the client stores the new local certificate for use when the current local certificate expires (block 258). Otherwise, an exception is indicated (block 259).

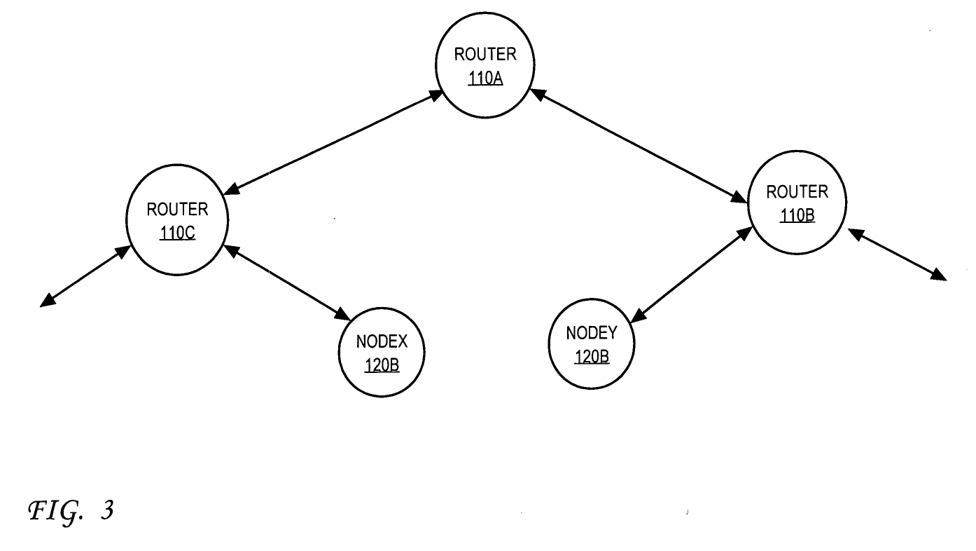

FIG. 3 is a functional diagram that illustrates a hierarchical relationship among nodes using the process of FIGS. 2A-2F. In the hierarchical arrangement of trusted entities, a subordinate CA, such as 110B behaves like a client toward a superior node, such as 110A. The subordinate CA 110B watches its own local certificate as well as the CA certificate of the superior CA for expiration. The client re-authenticates with the superior CA to obtain a new CA certificate using the procedure described above with reference to FIGS. 2E-2F. The subordinate node 110B behaves like a CA toward nodes inferior to it in the hierarchy, such as NODEY 120B in FIG. 3 using the procedure described above with reference to FIGS. 2A-2D.

4.0 Implementation Mechanisms—Hardware Overview

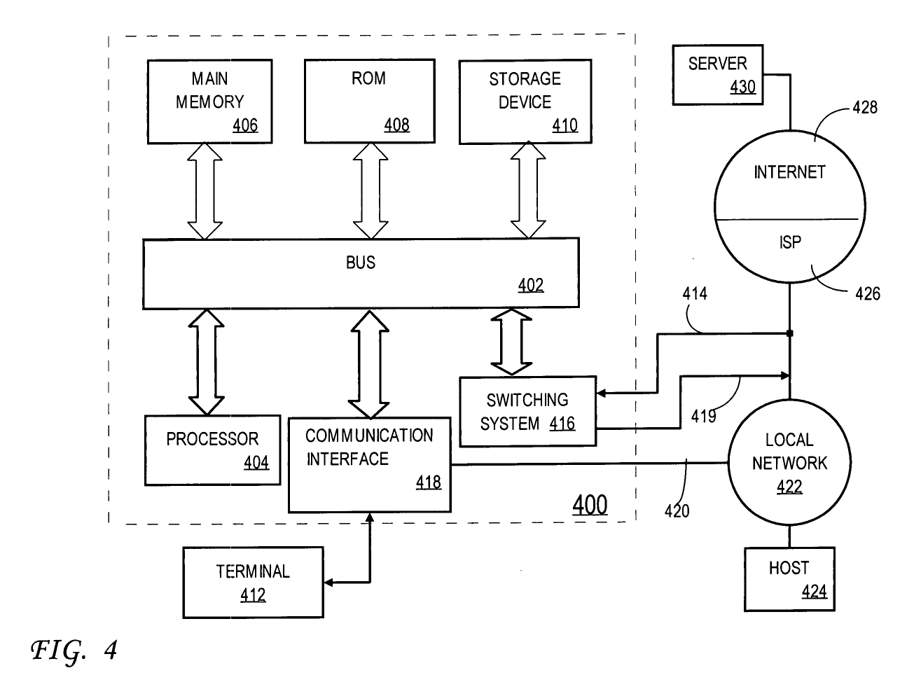

FIG. 4 is a block diagram that illustrates a computer system 400 upon which an embodiment of the invention may be implemented. The preferred embodiment is implemented using one or more computer programs running on a network element such as a router device. Thus, in this embodiment, the computer system 400 is a router.

Computer system 400 includes a bus 402 or other communication mechanism for communicating information, and a processor 404 coupled with bus 402 for processing information. Computer system 400 also includes a main memory 406, such as a random access memory (RAM), flash memory, or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk, flash memory or optical disk, is provided and coupled to bus 402 for storing information and instructions.

A communication interface 418 may be coupled to bus 402 for communicating information and command selections to processor 404. Interface 418 is a conventional serial interface such as an RS-232 or RS-422 interface. An external terminal 412 or other computer system connects to the computer system 400 and provides commands to it using the interface 414. Firmware or software running in the computer system 400 provides a terminal interface or character-based command interface so that external commands can be given to the computer system.

A switching system 416 is coupled to bus 402 and has an input interface 414 and an output interface 419 to one or more external network elements. The external network elements may include a local network 422 coupled to one or more hosts 424, or a global network such as Internet 428 having one or more servers 430. The switching system 416 switches information traffic arriving on input interface 414 to output interface 419 according to pre-determined protocols and conventions that are well known. For example, switching system 416, in cooperation with processor 404, can determine a destination of a packet of data arriving on input interface 414 and send it to the correct destination using output interface 419. The destinations may include host 424, server 430, other end stations, or other routing and switching devices in local network 422 or Internet 428.

The invention is related to the use of computer system 400 for continuing PKI operation while regenerating a new Certification Authority (CA) keypair and certificate. According to one embodiment of the invention, continuing PKI operation while regenerating a new Certification Authority (CA) keypair and certificate are provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Communication interface 418 also provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for continuing PKI operation while regenerating a new Certification Authority (CA) keypair and certificate as described herein.

The received code may be executed by processor 404 as it is received, and/or stored in storage device 410, or other non-volatile storage for later execution. In this manner, computer system 400 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of continuing operation of a public key infrastructure (PKI), comprising a certification authority (CA) and a requestor, the method comprising the computer-implemented steps of:
establishing a trust relationship between the requestor and the certification authority based upon a first CA certificate produced by the CA and signed using a first private key K1-private of a first keypair K1, and having a first validity period L1;
generating a second keypair K2, having a second public key K2-public and a second private key, K2-private; and
generating a future valid second CA certificate signed with a second private key K2-private of the second keypair K2, and having a second validity period L2;
wherein an issuer name and a subject name of the first CA certificate and an issuer name and a subject name of the second CA certificate are substantially identical; and wherein the second validity period L2 begins substantially concurrently with expiration of the first validity period of the first CA certificate.

2. A method as recited in claim 1, further comprising the steps of:
receiving from the requestor a request for a new CA certificate;
preparing a message to the requester, wherein the message includes the second CA certificate;
signing the message using the first private key K1-private; and
sending the message to the requestor for storing the second certificate for use when the first certificate expires.

3. A method as recited in claim 2, further comprising the steps of:
receiving from a requestor a request for a new local certificate, wherein the request has been signed with the requestor's first private key rK1-private; wherein the request includes the first certificate signed with the Certification Authority's first private key K1-private and wherein the request is enveloped using the CA's second public key K2-public;
automatically generating a new local certificate having a validity period L3 that begins at the start of the second validity period L2 of the second CA certificate;
signing the local certificate using the second private key K2-private; and
sending the local certificate to the requestor for storing the local certificate for use when the requestor's current local certificate expires.

4. A method as recited in claim 3, wherein the request comprises a first data layer in PKCS#10 format that is signed with the requestor's second private key rK2-private key and a second data layer in PKCS#7 format comprising a local certificate signed by the CA with the Certificate Authority's first private key K1-private, wherein the local certificate comprises the requestor's first public key rK1-public.

5. A method as recited in claim 1, further comprising the steps of:
determining that the first CA certificate is expired; and
exchanging the second CA certificate for the first CA certificate at expiration of the first CA certificate.

6. A method as recited in claim 2, wherein preparing a message to the requestor comprises:
preparing a PKCS#7 message containing the second CA certificate and signed with the first private key K1-private.

7. A method as recited in claim 1, wherein the second keypair K2 is cryptographically unrelated to the first keypair K1.

8. A method of continuing operation of a public key infrastructure (PKI) comprising a certification authority (CA) and a requestor, the method comprising the computer-implemented steps of:
establishing a trust relationship between the requestor and the certification authority based upon a first CA certificate produced by the CA and signed using a first private key K1-private of a first keypair K1, and having a first validity period L1;
determining that the first CA certificate is about to expire;
sending a request to the Certification Authority for a new CA certificate; and
storing the new CA certificate for use when the first certificate expires, if the new CA certificate is received.

9. A method as recited in claim 8, further comprising:
determining that a current local certificate is about to expire;
sending a request to the Certification Authority for a new local certificate, wherein the request has been signed with the requestor's first private key rK1-private; wherein the request includes the first certificate signed with the Certification Authority's first private key K1-private and wherein the request is enveloped using the CA's second public key K2-public; and
storing the new local certificate for use when the current local certificate expires, if the new local certificate is received.

10. A method of continuing operation of a public key infrastructure (PKI) comprising a certification authority (CA) and a requestor, the method comprising the computer-implemented steps of:
establishing a trust relationship between the requestor and the certification authority based upon a first CA certificate produced by the CA and signed using a first private key K1-private of a first keypair K1, and having a first validity period L1;
generating a second keypair K2, having a second public key K2-public and a second private key, K2-private, and wherein the second keypair K2 is not cryptographically related to the first keypair K1;
generating a future valid second CA certificate signed with a second private key K2-private of the second keypair K2, and having a second validity period L2;
wherein an issuer name and a subject name of the first CA certificate and an issuer name and a subject name of the second CA certificate are substantially identical; and wherein the second validity period L2 begins substantially concurrently with expiration of the first validity period of the first CA certificate;
receiving from the requestor a request for a new CA certificate;
preparing a message to the requestor, wherein the message includes the second CA certificate;
signing the message using the first private key K1-private; and
sending the message to the requestor for storing the second certificate for use when the first certificate expires.

11. A computer-readable medium carrying one or more sequences of instructions for continuing operation of a public key infrastructure (PKI) comprising a certification authority (CA) and a requestor, which instructions, when executed by one or more processors, cause the one or more processors to carry out the steps of:
establishing a trust relationship between the requestor and the certification authority based upon a first CA certificate produced by the CA and signed using a first private key K1-private of a first keypair K1, and having a first validity period L1;
generating a second keypair K2, having a second public key K2-public and a second private key, K2-private; and
generating a future valid second CA certificate signed with a second private key K2-private of the second keypair K2, and having a second validity period L2;
wherein an issuer name and a subject name of the first CA certificate and an issuer name and a subject name of the second CA certificate are substantially identical; and wherein the second validity period L2 begins substantially concurrently with expiration of the first validity period of the first CA certificate.

12. A computer-readable medium as recited in claim 11, further comprising instructions which, when executed by the one or more processors, cause the one or more processors to carry out the steps of:
receiving from the requestor a request for a new CA certificate;
preparing a message to the requester, wherein the message includes the second CA certificate;
signing the message using the first private key K1-private; and
sending the message to the requestor for storing the second certificate for use when the first certificate expires.

13. A computer-readable medium as recited in claim 12, further comprising instructions which, when executed by the one or more processors, cause the one or more processors to carry out the steps of:
receiving from a requestor a request for a new local certificate, wherein the request has been signed with the requestor's first private key rK1-private; wherein the request includes the first certificate signed with the Certification Authority's first private key K1-private and wherein the request is enveloped using the CA's second public key K2-public; automatically generating a new local certificate having a validity period L3 that begins at the start of the second validity period L2 of the second CA certificate;
signing the local certificate using the second private key K2-private; and
sending the local certificate to the requestor for storing the local certificate for use when the requestor's current local certificate expires.

14. A computer-readable medium as recited in claim 13, wherein the request comprises a first data layer in PKCS#10 format that is signed with the requestor's second private key rK2-private key and a second data layer in PKCS#7 format comprising a local certificate signed by the CA with the Certificate Authority's first private key K1-private, wherein the local certificate comprises the requestor's first public key rK1-public.

15. A computer-readable medium as recited in claim 11, further comprising instructions which, when executed by the one or more processors, cause the one or more processors to carry out the steps of:
determining that the first CA certificate is expired; and
exchanging the second CA certificate for the first CA certificate at expiration of the first CA certificate.

16. A computer-readable medium as recited in claim 12, wherein the instructions for preparing a message to the requestor further comprise instructions for carrying out the steps of:
preparing a PKCS#7 message containing the second CA certificate and signed with the first private key K1-private.

17. A computer-readable medium as recited in claim 11, wherein the second keypair K2 is cryptographically unrelated to the first keypair K1.

18. A computer-readable medium carrying one or more sequences of instructions for continuing operation of a public key infrastructure (PKI) comprising a certification authority (CA) and a requestor, which instructions, when executed by one or more processors, cause the one or more processors to carry out the steps of:
establishing a trust relationship between the requestor and the certification authority based upon a first CA certificate produced by the CA and signed using a first private key K1-private of a first keypair K1, and having a first validity period L1;
determining that the first CA certificate is about to expire;
sending a request to the Certification Authority for a new CA certificate; and
storing the new CA certificate for use when the first certificate expires, if the new CA certificate is received.

19. A computer-readable medium as recited in claim 18, further comprising instructions which, when executed by the one or more processors, cause the one or more processors to carry out the steps of:
determining that a current local certificate is about to expire;
sending a request to the Certification Authority for a new local certificate, wherein the request has been signed with the requestor's first private key rK1-private; wherein the request includes the first certificate signed with the Certification Authority's first private key K1-private and wherein the request is enveloped using the CA's second public key K2-public; and
storing the new local certificate for use when the current local certificate expires, if the new local certificate is received.

20. An apparatus for continuing operation of a public key infrastructure (PKI) comprising a certification authority (CA) and a requester, the apparatus comprising:
a network interface that is coupled to the data network for receiving one or more packet flows therefrom;
a processor;
one or more stored sequences of instructions which, when executed by the processor, cause the processor to carry out the steps of:
establishing a trust relationship between the requestor and the certification authority based upon a first CA certificate produced by the CA and signed using a first private key K1-private of a first keypair K1, and having a first validity period L1;
generating a second keypair K2, having a second public key K2-public and a second private key, K2-private; and
generating a future valid second CA certificate signed with a second private key K2-private of the second keypair K2, and having a second validity period L2;
wherein an issuer name and a subject name of the first CA certificate and an issuer name and a subject name of the second CA certificate are substantially identical; and wherein the second validity period L2 begins substantially concurrently with expiration of the first validity period of the first CA certificate.

21. An apparatus as recited in claim 20, further comprising instructions which, when executed by the processor, cause the processor to carry out the steps of:
receiving from the requestor a request for a new CA certificate;
preparing a message to the requester, wherein the message includes the second CA certificate;
signing the message using the first private key K1-private; and
sending the message to the requestor for storing the second certificate for use when the first certificate expires.

22. An apparatus as recited in claim 21, further comprising instructions which, when executed by the processor, cause the processor to carry out the steps of:
receiving from a requestor a request for a new local certificate, wherein the request has been signed with the requestor's first private key rK1-private; wherein the request includes the first certificate signed with the Certification Authority's first private key K1-private and wherein the request is enveloped using the CA's second public key K2-public;
automatically generating a new local certificate having a validity period L3 that begins at the start of the second validity period L2 of the second CA certificate;
signing the local certificate using the second private key K2-private; and
sending the local certificate to the requestor for storing the local certificate for use when the requestor's current local certificate expires.

23. A apparatus as recited in claim 22, wherein the request comprises a first data layer in PKCS#10 format that is signed with the requestor's second private key rK2-private key and a second data layer in PKCS#7 format comprising a local certificate signed by the CA with the Certificate Authority's first private key K1-private, wherein the local certificate comprises the requestor's first public key rK1-public.

24. An apparatus as recited in claim 20, further comprising instructions which, when executed by the processor, cause the processor to carry out the steps of:
determining that the first CA certificate is expired; and
exchanging the second CA certificate for the first CA certificate at expiration of the first CA certificate.

25. An apparatus as recited in claim 21, wherein the instructions for preparing a message to the requestor further comprise instructions which, when executed by the processor, cause the processor to carry out the steps of:
preparing a PKCS#7 message containing the second CA certificate and signed with the first private key K1-private.

26. An apparatus as recited in claim 20, wherein the second keypair K2 is cryptographically unrelated to the first keypair K1.

27. An apparatus for continuing operation of a public key infrastructure (PKI) comprising a certification authority (CA) and a requester, the apparatus comprising:
a network interface that is coupled to the data network for receiving one or more packet flows therefrom;
a processor;
one or more stored sequences of instructions which, when executed by the processor, cause the processor to carry out the steps of:
establishing a trust relationship between the requestor and the certification authority based upon a first CA certificate produced by the CA and signed using a first private key K1-private of a first keypair K1, and having a first validity period L1;
determining that the first CA certificate is about to expire;
sending a request to the Certification Authority for a new CA certificate; and
storing the new CA certificate for use when the first certificate expires, if the new CA certificate is received.

28. An apparatus as recited in claim 27, further comprising instructions which, when executed by the processor, cause the processor to carry out the steps of:
determining that a current local certificate is about to expire;
sending a request to the Certification Authority for a new local certificate, wherein the request has been signed with the requestor's first private key rK1-private; wherein the request includes the first certificate signed with the Certification Authority's first private key K1-private and wherein the request is enveloped using the CA's second public key K2-public; and
storing the new local certificate for use when the current local certificate expires, if the new local certificate is received.

29. An apparatus for continuing operation of a public key infrastructure (PKI), comprising a certification authority (CA) and a requestor, the apparatus comprising:
means for establishing a trust relationship between the requestor and the certification authority based upon a first CA certificate produced by the CA and signed using a first private key K1-private of a first keypair K1, and having a first validity period L1;
means for generating a second keypair K2, having a second public key K2-public and a second private key, K2-private; and
means for generating a future valid second CA certificate signed with a second private key K2-private of the second keypair K2, and having a second validity period L2;
wherein an issuer name and a subject name of the first CA certificate and an issuer name and a subject name of the second CA certificate are substantially identical; and wherein the second validity period L2 begins substantially concurrently with expiration of the first validity period of the first CA certificate.
